(19) United States
(12) Patent Application Publication
(10) Pub. No.: US 2017/0046588 A1
(43) Pub. Date: Feb. 16, 2017

(54) SYSTEMS, METHODS, AND COMPUTER PROGRAMS TO LOCATE PORTIONS OF PATTERNS FOR MEASUREMENT IN SEM IMAGES

(71) Applicant: Samsung Electronics Co., Ltd., Suwon-si (KR)

(72) Inventor: Hyung-Joon Cho, Suwon-si (KR)

(21) Appl. No.: 15/172,438

(22) Filed: Jun. 3, 2016

(30) Foreign Application Priority Data
Aug. 13, 2015 (KR) 10-2015-0114498

(51) Int. Cl. G06K 9/46

(52) U.S. Cl. CPC G06K 9/4604; G06K 9/4671

(57) ABSTRACT

A system can locate patterns for measurement in a captured Scanning Electron Microscope (SEM) image. The system can include a processor circuit that can be configured to generate a target pattern from a layout of a semiconductor device, and configured to generate a virtual image that corresponds to the target pattern, wherein elements of the virtual image less than completely overlap the corresponding portions of the target pattern, and configured to locate portions of a captured SEM image of a fabricated semiconductor device that match the elements of the virtual image.

This application claims priority from Korean Patent Application No. 10-2015-0114498 filed on Aug. 13, 2015 in the Korean Intellectual Property Office, the disclosure of which is incorporated herein by reference in its entirety.

### FIELD

The present inventive concept relates to a method of measuring line widths of patterns.

### BACKGROUND

In the fabrication of a semiconductor device, accurately measuring fine patterns formed by a photolithography process, an etching process, etc. is needed. Before or after a fine pattern forming process, an electrical characteristic test is performed, or line widths of fine patterns may be measured in order to check whether the fine patterns are to be or have been formed according to accurate measurements.

For example, a scanning electron microscope (SEM) may be used as equipment for measuring the critical dimension (CD) of fine line widths. Here, the CD is defined as a spatial limit between interconnected lines of a semiconductor device and as a width of the lines. That is, the CD is a minimum space or minimum circuit line width allowed between two lines in the fabrication of a semiconductor device.

Generally, an SEM image is obtained by irradiating an electron beam in a direction perpendicular to a lengthwise direction of patterns formed on a sample. Here, a region of interest (ROI) is set by a measurement recipe or a worker, and then line widths of the patterns are measured within the ROI.

### SUMMARY

Embodiments according to the inventive concept can provide a system that is configured to locate patterns for measurement in a captured Scanning Electron Microscope (SEM) image, where the system can include a processor circuit that can be configured to generate a target pattern from a layout of a semiconductor device, and configured to generate a virtual image that corresponds to the target pattern, wherein elements of the virtual image less than completely overlap the corresponding portions of the target pattern, and configured to locate portions of a captured SEM image of a fabricated semiconductor device that match the elements of the virtual image.

In some embodiments according to the inventive concept, a method of locating patterns for measurement in a captured Scanning Electron Microscope (SEM) image can include generating a first image including target patterns for fabrication of a semiconductor device. A second image can be generated by extracting an outline of each of the target patterns and the target patterns included in the first image can be matched with patterns included in a captured SEM image of a fabricated semiconductor device using the second image.

In some embodiments according to the inventive concept, a method of locating patterns for measurement in a Scanning Electron Microscope (SEM) image can include providing a target image including patterns and generating, from the target image, a virtual image having a line shape. The target image and the virtual image can be compared with an SEM image including the patterns.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is a flowchart illustrating a method of measuring line widths of patterns according to embodiments of the present inventive concept;

FIG. 2 is a block diagram of an apparatus for measuring line widths of patterns according to embodiments of the present inventive concept;

FIG. 3 is a flowchart illustrating a method of measuring line widths of patterns according to embodiments of the present inventive concept;

FIG. 4 is a flowchart illustrating a method of measuring line widths of patterns according to embodiments of the present inventive concept;

FIG. 5 is a flowchart illustrating a method of measuring line widths of patterns according to embodiments of the present inventive concept;

FIG. 6 shows an example of a scanning electron microscope (SEM) image of patterns;

FIG. 7 illustrates an example of a target image of patterns;

FIG. 8 illustrates an example of a first virtual image generated based on the target image shown in FIG. 7;

FIG. 9 illustrates an example of a second virtual image generated based on the target image shown in FIG. 7;

FIGS. 10 through 12 are diagrams illustrating a method of generating a virtual image including a second line shape;

FIG. 13 illustrates an example of a third virtual image generated based on the target image shown in FIG. 7;

FIGS. 14 through 16 are diagrams illustrating a method of generating a virtual image including a third line shape; and

FIG. 17 is a block diagram of an electronic system including semiconductor devices formed using methods of measuring line widths of patterns according to embodiments of the present inventive concept.

FIG. 18 shows an example of a generic computing device 1800, which may be used locate portions of patterns for measurement in SEM images.

### DETAILED DESCRIPTION OF EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art. The same reference numbers indicate the same components throughout the specification. In the attached figures, the thickness of layers and regions is exaggerated for clarity.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

The present invention will be described with reference to perspective views, cross-sectional views, and/or plan views, in which preferred embodiments of the invention are shown. Thus, the profile of an exemplary view may be modified according to manufacturing techniques and/or allowances. That is, the embodiments of the invention are not intended to limit the scope of the present invention but cover all changes and modifications that can be caused due to a change in manufacturing process. Thus, regions shown in the drawings are illustrated in schematic form and the shapes of the regions are presented simply by way of illustration and not as a limitation.

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, server, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, server, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, server, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

As appreciated by the present inventors, in scanning electron microscope (SEM) measurement performed after the manufacture of semiconductor patterns, a critical dimension (CD) target image stored in a recipe is displayed on an SEM image window, and then line widths of the semiconductor patterns are measured. To display a CD measurement target and point on the SEM image window of an SEM equipment monitor in the SEM measurement, a target image to be displayed is stored in the process of creating an SEM recipe.

In addition, to make the target image be displayed at a predetermined location on the SEM image window when the recipe is executed, a display function is operated by modifying a pattern recognition function currently being used from among recipe creation options or adding an image storage function.

When the recipe is executed, wafer alignment is performed after the execution of the recipe is checked, and then CD measurement is started. Here, if an SEM image and the target image do not accurately match each other, a worker has to manually match the SEM image and the target image. Accordingly, as appreciated by the present inventors, embodiments according to the present inventive concept can reduce errors otherwise associated with identification of features to be measured for compliance with the critical dimension. For example, a virtual image can be generated based on a target image which can simplify representations of the patterns that are to be checked by the SEM process. Simplifying the representations of the patterns can avoid misidentification of locations where the CD parameter is to be checked. Accordingly, when the SEM image is checked for compliance with the CD rule, it is more likely that the actual locations where the measurements are made are the actual locations intended.

Methods of measuring line widths of patterns according to embodiments of the present inventive concept may address the above problem of having to manually match the SEM image and the target image and improve the accuracy of matching between the SEM image and the target image, thereby reducing the process cost and time.

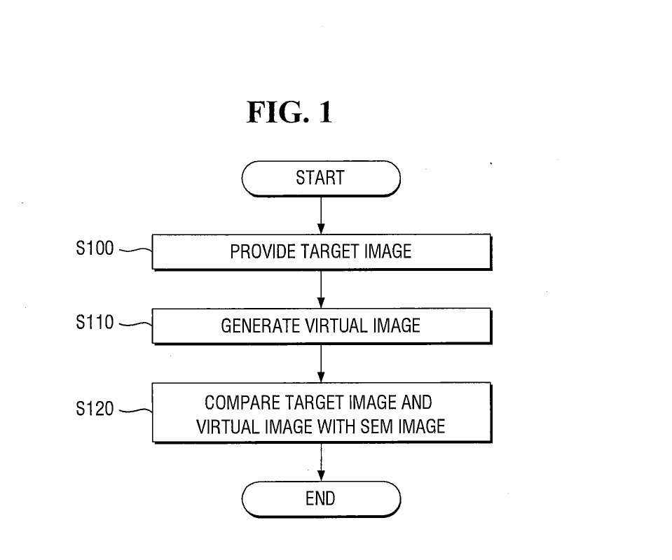

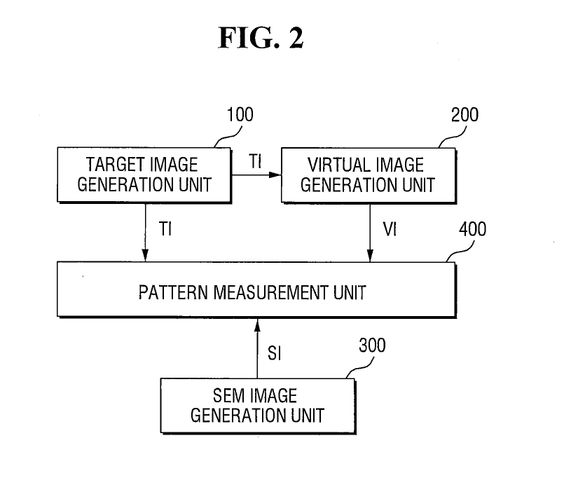

FIG. 1 is a flowchart illustrating a method of measuring line widths of patterns according to embodiments of the present inventive concept. FIG. 2 is a block diagram of an apparatus for measuring line widths of patterns according to embodiments of the present inventive concept.

Referring to FIG. 1, in the method of measuring line widths of patterns, a target image T1 of patterns is provided (operation S100). The target image TI is an image of patterns (e.g., semiconductor patterns) to be formed sometimes referred to as an ideal image.

Next, a virtual image VI including a line shape formed using the target image Ti is generated (operation S110). The virtual image VI includes the line shape extracted from the target image TI according to a specific rule. The virtual image VI is an image that helps improve the accuracy of image matching when an SEM image SI and the target image TI are compared. The line shape of the virtual image VI may include, e.g., an outline of each of the patterns. Accordingly, in some embodiments, the virtual image is a schematic representation of the target image.

That is, when the virtual image VI including the outlines of the patterns is matched with the SEM image SI together with the target image TI, the outlines of the patterns in the virtual image VI may be matched with outlines actually shown in the SEM image SI, thereby increasing the accuracy of matching between the target image TI and the SEM image SI. When the virtual image VI is not used, pattern shapes of the target image TI may not accurately match, that is, may be misaligned with pattern shapes of the SEM image SI.

Next, the target image TI and the virtual image VI are compared with the SEM image SI of the patterns (operation S120). The comparing of the target image TI and the virtual image VI with the SEM image SI may include matching the target image TI and the SEM image SI.

Referring to FIG. 2, the apparatus for measuring line widths of patterns may include a target image generation unit 100, a virtual image generation unit 200, an SEM image generation unit 300, and a pattern measurement unit 400. It will be understood that in some embodiments according to the inventive concept, the term “unit” can refer to a hardware or software implementation or a combination of both hardware and software.

The target image generation unit 100 may generate a target image TI, specifically, a target image TI of target patterns intended by a designer. The target image TI generated by the target image generation unit 100 may be provided to the virtual image generation unit 200 and the pattern measurement unit 400.

The virtual image generation unit 200 may generate a virtual image VI from the target image TI according to a specific rule. The virtual image VI generated by the virtual image generation unit 200 may be provided to the pattern measurement unit 400. The virtual image generation unit 200, the target image generation unit 100, and the pattern measurement unit 400 may be implemented by at least one processor circuit which is operatively coupled to the SEM image generation unit 300.

The SEM image generation unit 300 may generate an SEM image SI of actually manufactured patterns (e.g., semiconductor patterns). The sequence of generating the SEM image SI is as follows.

To generate the SEM image SI, a substrate having patterns (e.g., semiconductor patterns) is prepared. The substrate may be a semiconductor substrate such as a wafer or a reticle.

Next, the patterns are scanned by irradiating primary electrons onto the patterns using an SEM. Then, image data of the patterns is obtained by detecting secondary electrons emitted from the patterns.

Here, the secondary electrons are electrons into which atoms of the substrate have been ionized by the primary electrons. The secondary electrons may have different energy according to the surface of the substrate or the shape of the patterns. For example, secondary electrons having high energy may be generated on a sloping surface of a pattern rather than on an upper surface of the pattern. In addition, secondary electrons having high energy may be generated on an edge portion of the pattern with the substrate rather than on the sloping surface of the pattern.

Electric currents of different intensities are generated according to the energy levels of secondary electrons emitted at different intensities according to the shapes of the patterns. The electric currents are converted into image data of the patterns through an amplification process.

The pattern measurement unit 400 may receive the target image TI, the virtual image VI and the SEM image SI and measure line widths of the patterns. Specifically, the pattern measurement unit 400 may set a detection region in the SEM image SI by matching the designed target patterns included in the target image TI and patterns included in the virtual image VI generated from the target image TI with the patterns included in the SEM image SI.

The pattern measurement unit 400 may measure the line widths of the patterns in the set detection region and display the measured line widths of the patterns.

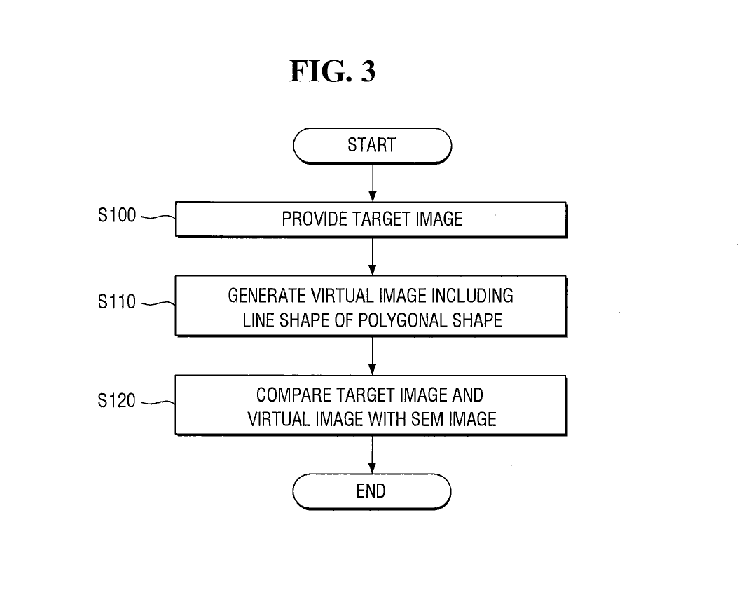

FIG. 3 is a flowchart illustrating a method of measuring line widths of patterns according to embodiments of the present inventive concept.

Referring to FIG. 3, a target image TI of patterns is provided (operation S100).

A first virtual image VI1 including a line shape of each polygonal shape P is generated (operation S111). Here, the line shape of each polygonal shape P may include straight lines as well as an outline.

The target image TI and the first virtual image VI1 are compared with an SEM image SI of the patterns (operation S120). The comparing of the target image TI and the first virtual image VI1 with the SEM image SI may include matching the target image TI and the SEM image SI using the first virtual image VI1.

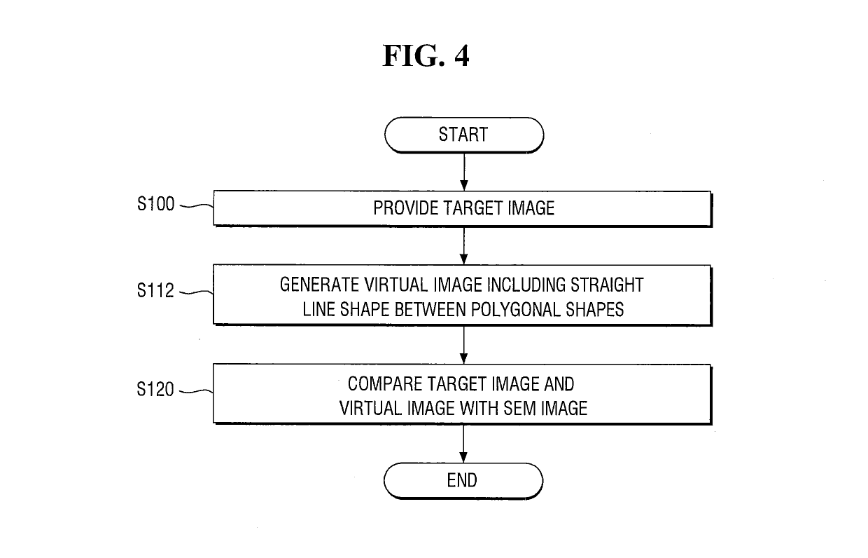

FIG. 4 is a flowchart illustrating a method of measuring line widths of patterns according to embodiments of the present inventive concept.

Referring to FIG. 4, in the method of measuring line widths of patterns, a target image TI of patterns is provided (operation S100).

Then, a second virtual image VI2 including a straight line shape between a plurality of polygonal shapes P is generated (operation S112). Here, the straight line shape between the polygonal shapes P may be formed according to a specific rule. In particular, the second virtual image VI2 may be generated by forming straight lines that connect adjacent polygonal shapes P.

Next, the target image TI and the second virtual image VI2 are compared with an SEM image of the patterns (operation S120). Comparing the target image TI and the second virtual image VI2 with the SEM image SI may include matching the target image TI and the SEM image SI using the second virtual image VI2.

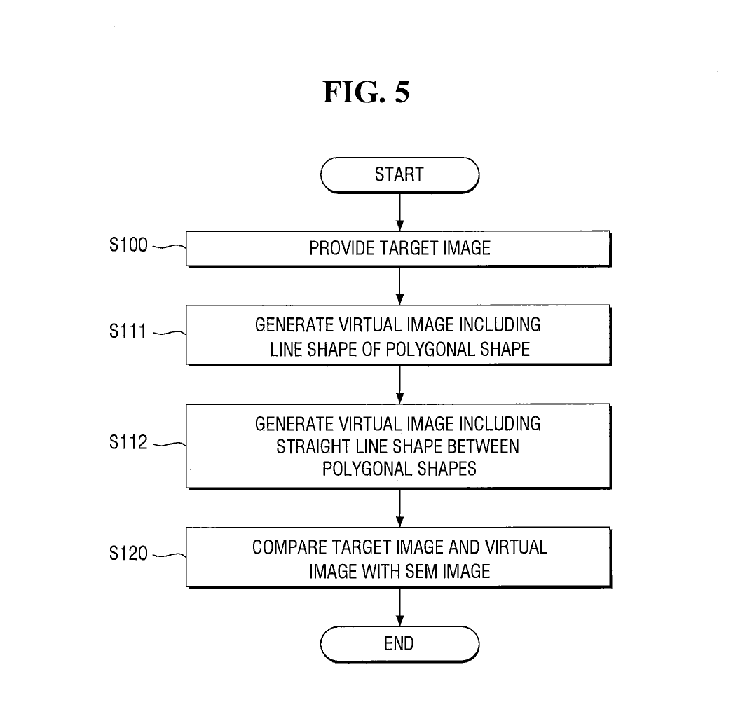

FIG. 5 is a flowchart illustrating a method of measuring line widths of patterns according to embodiments of the present inventive concept.

Referring to FIG. 5, in the method of measuring line widths of patterns, a target image TI of patterns is provided (operation S100).

A first virtual image VI1 including a line shape of each polygonal shape P is generated (operation S111). Here, the line shape of each polygonal shape P may include straight lines as well as an outline.

Next, a second virtual image VI2 including a straight line shape between a plurality of polygonal shapes P is generated (operation S112). Here, the straight line shape between the polygonal shapes P may be formed according to a specific rule. In particular, the second virtual image VI2 may be generated by forming straight lines that connect or extend between adjacent polygonal shapes P.

A third virtual image VI3 is generated by combining the first and second virtual images VI1 and VI2, whereupon the target image TI and the third virtual image VI3 are compared with an SEM image SI of the patterns (operation S120). Comparing the target image TI and the third virtual image VI3 with the SEM image SI may including matching the target image TI and the SEM image SI using the third virtual image VI3.

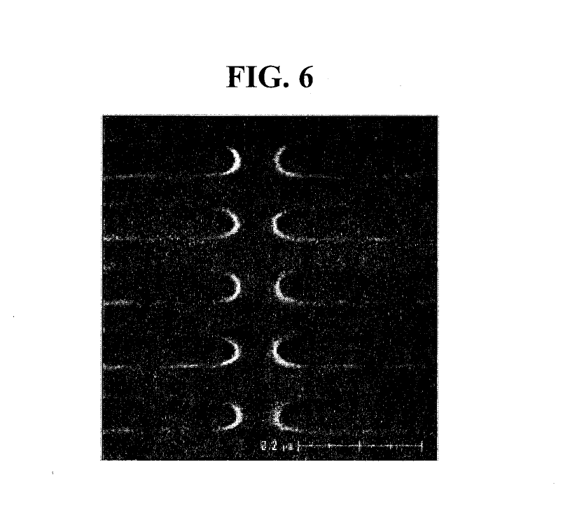

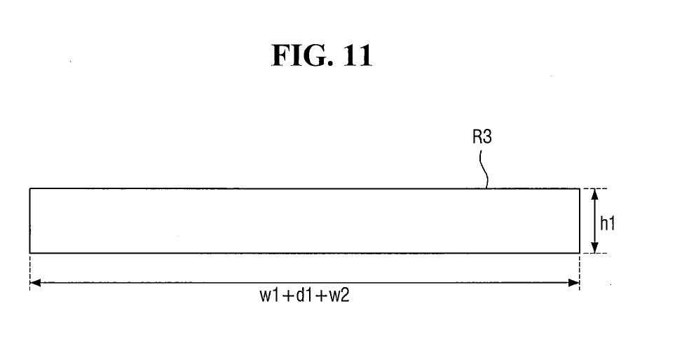

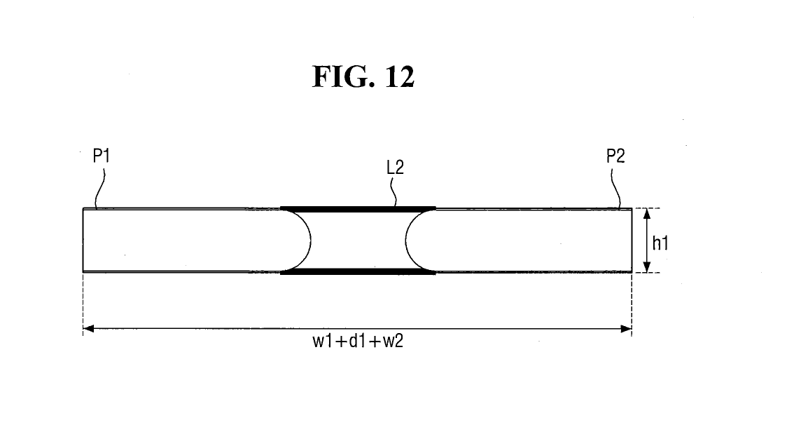

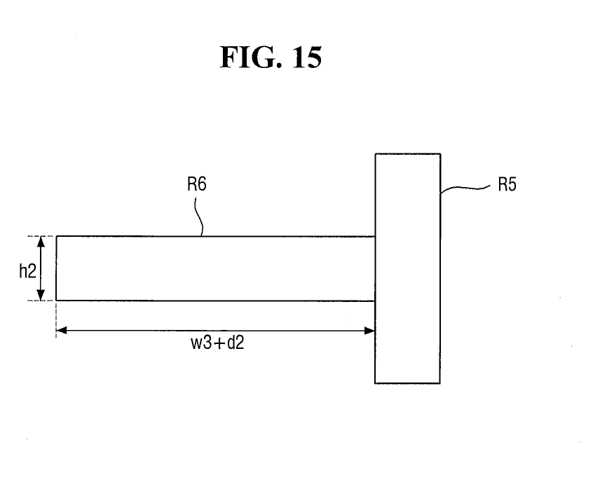

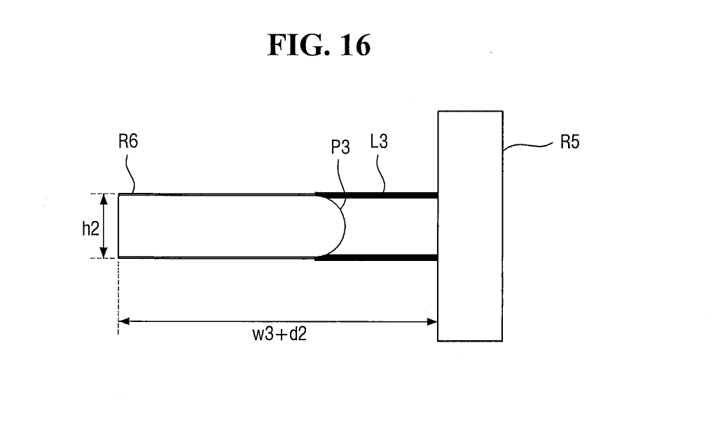

Rules for generating a virtual image will now be described with reference to FIGS. 6 through 16.

FIG. 6 shows an example of an SEM image of patterns.

In FIG. 6, an SEM image SI of actual patterns is shown. The SEM image SI includes not only the patterns but also outlines (white lines) of the patterns and straight lines (black lines) between adjacent patterns. When first through third virtual images VI1. through VI3 are generated, these outlines and straight lines may be formed according to specific rules. The target image TI and the first through third virtual images VI1 through VI3 may be compared with the SEM image SI.

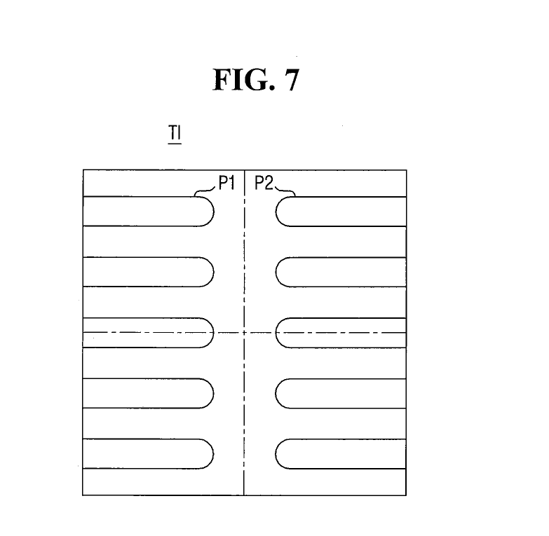

FIG. 7 illustrates an example of a target image of patterns.

In FIG. 7, a target image TI is illustrated. The target image TI is an image of designed (or ideal) patterns to be actually manufactured. The target image TI corresponds to an SEM image SI of actually manufactured patterns. The target image TI includes a first polygonal shape P1 and a second polygonal shape P2. The first polygonal shape P1 and the second polygonal shape P2 may be disposed adjacent to each other.

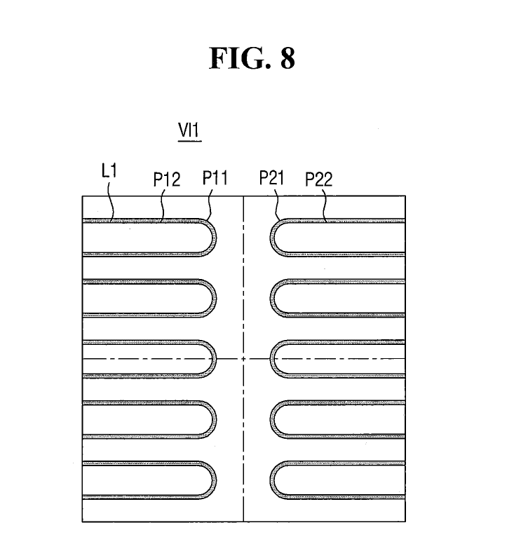

FIG. 8 illustrates an example of a first virtual image generated based on a target image.

Referring to FIG. 8, a first virtual image VI1 includes a first line shape L1 associated with each first polygonal shape P11 and a second polygonal shape P21. The first line shape L1 is formed for each of a plurality of polygonal shapes and corresponds to each white line in an SEM image SI. Therefore, the SEM image SI and a target image TI can be automatically matched using the first virtual image VI1 that expresses the white lines of the SEM image SI.

Specifically, according to a rule for forming the first virtual image VI1, a first sub-polygonal shape P12 smaller than the first polygonal shape P11 is formed in the first polygonal shape P11, and the first line shape L1 is completed by removing the first sub-polygonal shape P12 from the first polygonal shape P11. For example, the first line shape L1 may have a thickness of, but not limited to, 3 nm.

Likewise, a second sub-polygonal shape P22 smaller than the second polygonal shape P21 is formed in the second polygonal shape P21, and the first line shape L1 is completed by removing the second sub-polygonal shape P22 from the second polygonal shape P21. The same rule is applied to a plurality of polygonal shapes to complete the first line shape L1 of each of the polygonal shapes. Accordingly, the sub-polygonal shapes P12 and P22 can provide a type of filtering when applied to the polygonal shapes P11 and P21, respectively. In other words, the sub-polygonal shapes can be used to filter low frequency components of the image data found in the SEM image while maintaining the relatively high frequency components expressed by the edges of the patterns.

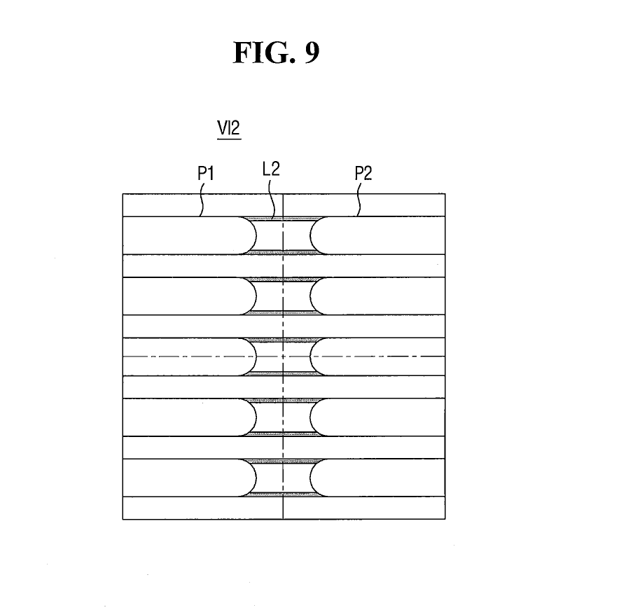

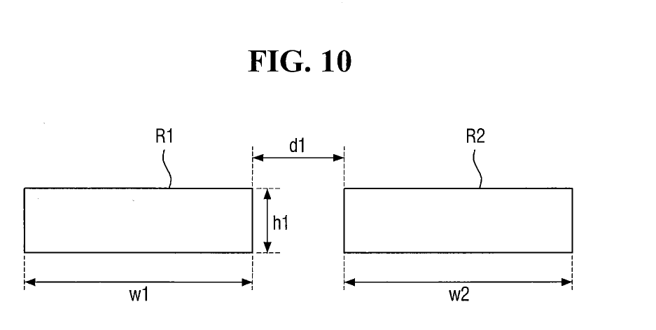

FIG. 9 illustrates an example of a second virtual image generated based on a target image. FIGS. 10 through 12 are diagrams illustrating a method of generating a virtual image including a second line shape.

Referring to FIG. 9, a second virtual image VI2 includes a second line shape L2 formed between a first polygonal shape P1 and a second polygonal shape P2. The second line shape L2 is formed between every two adjacent ones of a plurality of polygonal shapes and corresponds to black lines in an SEM image SI. Therefore, the SEM image SI and the target image VI can be automatically matched using the second virtual image VI2 that expresses the black lines of the SEM image SI.

Specifically, referring to FIGS. 10 through 12, according to a rule for generating the second virtual image VI2, a first quadrilateral shape R1 corresponding to the first polygonal shape P1 is formed, and a second quadrilateral shape R2 corresponding to the second polygonal shape P2 is formed. The first quadrilateral shape R1 may have a width of w1 and a height of h1. In addition, the second quadrilateral shape R2 may have a width of w2 and a height of h1. A distance between the first quadrilateral shape R1 and the second quadrilateral shape R2 may be d1.

Then, a third quadrilateral shape R3 may be formed by connecting the first quadrilateral shape R1 and the second quadrilateral shape R2. Here, the third quadrilateral shape R3 may have a width of w1+d1+w2 and a height of h1.

Here, the first polygonal shape P1 and the second polygonal shape P2 may be removed from the third quadrilateral shape R3, and the second line shape L2 extending along a lengthwise direction of the third quadrilateral shape R3 may be extracted from the remaining portion of the third quadrilateral shape R3. Accordingly, the second virtual image VI2 including the second line shape L2 can be generated.

When the first quadrilateral shape R1 corresponding to the first polygonal shape P1 is formed, at least part of an outline of the first polygonal shape P1 may contact an outline of the first quadrilateral shape R1. In addition, when the second quadrilateral shape R2 corresponding to the second polygonal shape P2 is formed, at least part of an outline of the second polygonal shape P2 may contact an outline of the second quadrilateral shape R2. That is, upper and lower lines of the first polygonal shape P1 may contact upper and lower lines of the first quadrilateral shape R1, respectively, and upper and lower lines of the second polygonal shape P2 may contact upper and lower lines of the second quadrilateral shape R2, respectively.

Therefore, by removing the first polygonal shape P1 and the second polygonal shape P2 from the third quadrilateral shape R3 and extracting the second line shape L2 extending along the lengthwise direction of the third quadrilateral shape R3 from the remaining portion of the third quadrilateral shape R3, the second line shape L2 including two lines parallel to each other can be formed.

For example, the second line shape L2 may have a thickness of, but not limited to, 3 nm. In addition, h1 may be, but is not limited to, less than 200 nm, w1 and w2 may be, but are not limited to, 300 nm or more, and d1 may be, but is not limited to, less than 200 nm.

The same rule may be applied to a plurality of polygonal shapes to form the second line shape L2 between every two adjacent ones of the polygonal shapes.

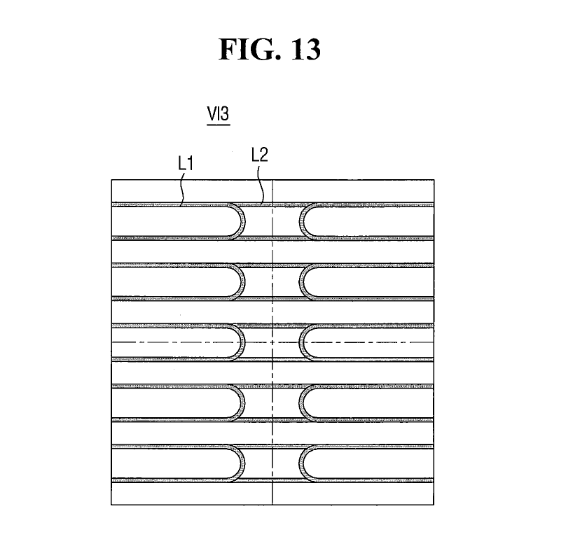

FIG. 13 illustrates an example of a third virtual image generated based on a target image.

Referring to FIG. 13, a third virtual image VI3 including a first line shape L1 and a second line shape L2 can be generated according to the above-described rules. The third virtual image VI3 can further improve the accuracy of matching between an SEM image SI and a target image TI.

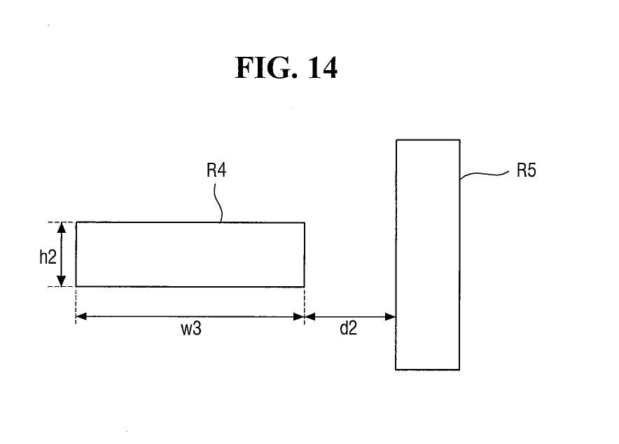

FIGS. 14 through 16 are diagrams illustrating a method of generating a virtual image including a third line shape.

In FIGS. 14 through 16, a rule for forming a third line shape L3 is illustrated.

The third line shape L3 corresponds to black lines formed between a third polygonal shape P3 extending along a first direction and a fifth quadrilateral shape R5 extending along a second direction perpendicular to the first direction.

The third polygonal shape P3 and the fifth quadrilateral shape R5 may be patterns disposed directly adjacent to each other. Accordingly, in some embodiments according to the inventive concept, the patterns which are directly adjacent to each other are disposed such that no intervening patterns are located between the patterns which are said to be directly adjacent to one another.

Specifically, according to the rule for forming the third line shape L3, a fourth quadrilateral shape R4 corresponding to the third polygonal shape P3 may be formed. The fourth quadrilateral shape R4 may have a width of w3 and a height of h2. A distance between the fourth quadrilateral shape R4 and the fifth quadrilateral shape R5 may be d2.

The fourth quadrilateral shape R4 may be extended to contact the fifth quadrilateral shape R5. Accordingly, a sixth quadrilateral shape R6 may be formed. The sixth quadrilateral shape R6 may have a width of w3+d2 and a height of h2.

Here, the third polygonal shape P3 may be removed from the sixth quadrilateral shape R6, and the third line shape L3 extending along a lengthwise direction of the sixth quadrilateral shape R6 may be extracted from the remaining portion of the sixth quadrilateral shape R6. Accordingly, a virtual image VI including the third line shape L3 may be generated.

When the fourth quadrilateral shape R4 corresponding to the third polygonal shape P3 is formed, at least part of an outline of the third polygonal shape P3 may contact an outline of the fourth quadrilateral shape R4. That is, upper and lower lines of the third polygonal shape P3 may contact upper and lower lines of the fourth quadrilateral shape R4, respectively.

Therefore, by removing the third polygonal shape P3 from the sixth quadrilateral shape R6 and extracting the third line shape L3 extending along the lengthwise direction of the sixth quadrilateral shape R6 from the remaining portion of the sixth quadrilateral shape R6, the third line shape L3 including two lines parallel to each other can be formed.

For example, the third line shape L3 may have a thickness of, but not limited to, 3 nm. In addition, h2 may be, but is not limited to, less than 200 nm, w3 may be, but is not limited to, 300 nm or more, and d2 may be, but is not limited to, less than 200 nm.

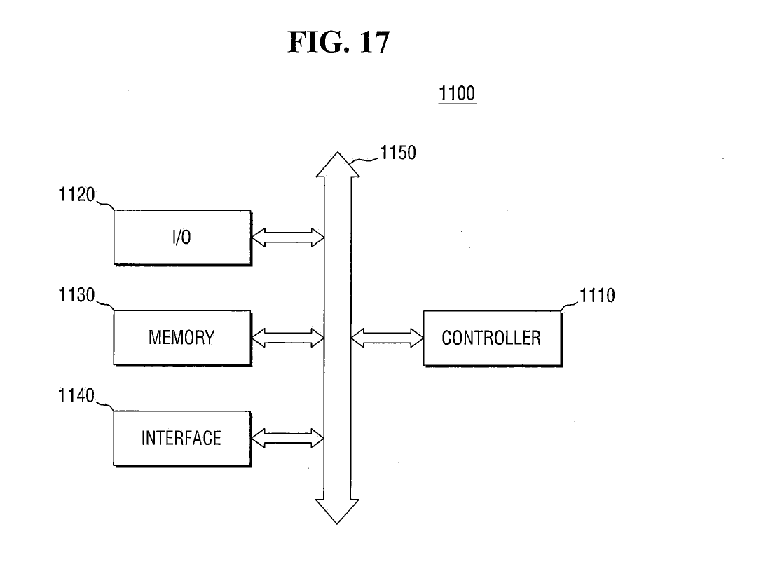

FIG. 17 is a block diagram of an electronic system 1100 including semiconductor devices formed using methods of measuring line widths of patterns according to embodiments of the present inventive concept.

Referring to FIG. 17, the electronic system 1100 may include a controller 1110, an input/output (I/O) device 1120, a memory device 1130, an interface 1140 and a bus 1150.

The controller 1110, the I/O device 1120, the memory device 1130 and/or the interface 1140 may be connected to one another by the bus 1150. The bus 1150 may serve as a path for transmitting data.

The controller 1110 may include at least one of a microprocessor, a digital signal processor, a microcontroller and logic devices capable of performing similar functions to those of a microprocessor, a digital signal processor and a microcontroller.

The I/O device 1120 may include a keypad, a keyboard and a display device. The memory device 1130 may store data and/or commands.

The interface 1140 may be used to transmit data to or receive data from a communication network. The interface 1140 may be a wired or wireless interface. In an example, the interface 1140 may include an antenna or a wired or wireless transceiver. The electronic system 1100 may further include a high-speed dynamic random access memory (DRAM) or static random access memory (SRAM) as a working memory for improving the operation of the controller 1110.

In addition, any one of semiconductor devices manufactured according to embodiments of the present inventive concept may be provided in the memory device 1130 or in the controller 1110 or the I/O device 1120.

The electronic system 1100 may be applied to nearly all types of electronic products capable of transmitting and/or receiving information in a wireless environment, such as a personal data assistant (PDA), a portable computer, a web tablet, a wireless phone, a mobile phone, a digital music player, a memory card, etc.

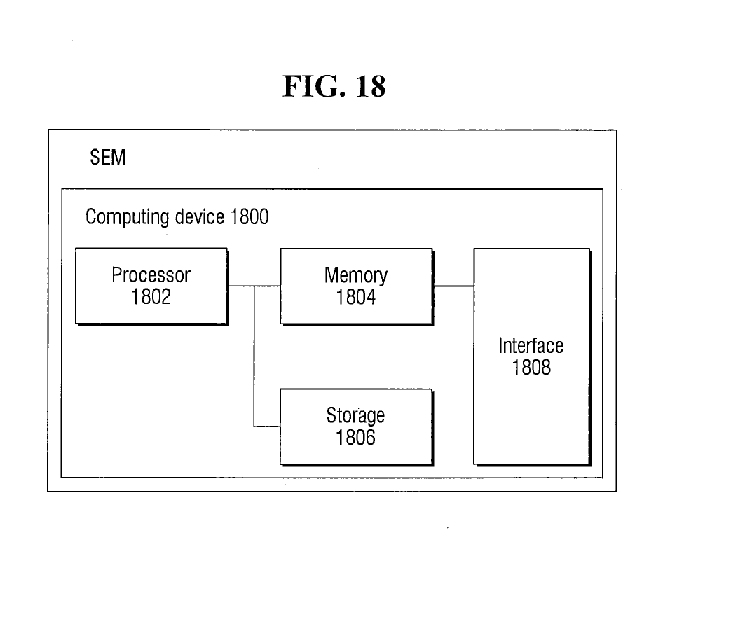

FIG. 18 is a block diagram showing example or representative computing devices and associated elements that may be used to carry out the operations described herein including the units shown in FIG. 2 to carry out the operations shown in each of the flowcharts herein.

FIG. 18 shows an example of a generic computing device 1800, which may be used locate portions of patterns for measurement in SEM images. As described herein. Computing device 1800 is intended to represent various forms of digital computers, such as laptops, desktops, workstations, personal digital assistants, servers, blade servers, mainframes, controllers, and other appropriate computers. The components shown herein, their connections and relationships, and their functions, are meant to be exemplary only, and are not meant to limit implementations of the inventions described and/or claimed.

Computing device 1800 includes a processor 1802, memory 1804, a storage device 1806, a high-speed interface 1808 connected to memory 1804. Each of the components, is interconnected using various buses, and may be mounted on a common motherboard or in other manners as appropriate. The processor 1802 can process instructions for execution within the computing device 1800, including instructions stored in the memory 1804 or on the storage device 1806 to display graphical information for a GUI on an external input/output device. In other implementations, multiple processors and/or multiple buses may be used, as appropriate, along with multiple memories and types of memory. Also, multiple computing devices 1800 may be connected, with each device providing portions of the necessary operations (e.g., as a server bank, a group of blade servers, or a multi-processor system).

The memory 1804 stores information within the computing device 1800. In one implementation, the memory 1804 is a volatile memory unit or units. In another implementation, the memory 1804 is a non-volatile memory unit or units. The memory 1804 may also be another form of computer-readable medium, such as a magnetic or optical disk.

The storage device 1806 is capable of providing mass storage for the computing device 1800. In one implementation, the storage device 1806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1804, the storage device 1806, or memory on processor 1802. Such allocation of functions is exemplary only.

The computing device 1800 may be implemented in a number of different forms. For example, it may be implemented as a standard server, or multiple times in a group of such servers. It may also be implemented as part of a rack server system. In addition, it may be implemented in a personal computer such as a laptop computer. Alternatively, components of computing device 1800 may be combined with other components.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims. It is therefore desired that the present embodiments be considered in all respects as illustrative and not restrictive, reference being made to the appended claims rather than the foregoing description to indicate the scope of the inventive concept.

What is claimed:

1. A method of locating patterns for measurement in a Scanning Electron Microscope (SEM) image, the method comprising:
providing a target image including patterns;
generating, from the target image, a virtual image having a line shape; and
comparing the target image and the virtual image with an SEM image including the patterns.

2. The method of claim 1, wherein comparing the target image and the virtual image with the SEM image comprises matching at least one portion of the target image and at least one portion of the SEM image using the virtual image.

3. The method of claim 1, wherein the line shape of the virtual image comprises an outline of each of the patterns included in the target image.

4. The method of claim 1, wherein the target image comprises a first polygonal shape, and generating the line shape comprises generating a second polygonal shape that is smaller than the first polygonal shape and generating the line shape comprises generating a first line shape using a difference between the first polygonal shape and the second polygonal shape.

5. The method of claim 1, wherein the target image comprises a third polygonal shape and a fourth polygonal shape adjacent to the third polygonal shape, and generating the line shape further comprises:
generating a first quadrilateral shape corresponding to the third polygonal shape;
generating a second quadrilateral shape corresponding to the fourth polygonal shape;
generating a third quadrilateral shape by connecting the first and second quadrilateral shapes;
removing the third and fourth polygonal shapes from the third quadrilateral shape; and
extracting a second line shape extending along a lengthwise direction of the third quadrilateral shape from a remaining portion of the third quadrilateral shape.

6. The method of claim 5, wherein at least part of an outline of the third polygonal shape overlaps an outline of the first quadrilateral shape, and at least part of an outline of the fourth polygonal shape overlaps an outline of the second quadrilateral shape.

7. The method of claim 6, wherein the second line shape comprises two lines extending parallel to each other.

8. The method of claim 5, wherein the target image comprises a fifth polygonal shape and a fourth quadrilateral shape adjacent to the fifth polygonal shape, and generating the line shape further comprises:
generating a fifth quadrilateral shape corresponding to the fifth polygonal shape;
extending the fifth quadrilateral shape to overlap the fourth quadrilateral shape;
removing the fifth polygonal shape from the extended fifth quadrilateral shape; and
extracting a third line shape extending along a lengthwise direction of the fifth quadrilateral shape from a remaining portion of the fifth quadrilateral shape.

9. The method of claim 8, wherein at least part of an outline of the fifth polygonal shape overlaps an outline of the fifth quadrilateral shape.

10. The method of claim 9, wherein the third line shape comprises two lines extending parallel to each other.

11. A method of locating patterns for measurement in a captured Scanning Electron Microscope (SEM) image, the method comprising:
generating a first image including target patterns for fabrication of a semiconductor device;
generating a second image by extracting an outline of each of the target patterns; and
matching the target patterns included in the first image with patterns included in a captured SEM image of a fabricated semiconductor device using the second image.

12. The method of claim 11, wherein matching the target patterns included in the first image with patterns included in the captured SEM image of a fabricated semiconductor device using the second image comprises matching the outlines included in the second image with outlines of the patterns included in the captured SEM image.

13. The method of claim 11, wherein generating the second image comprises generating sub-target patterns smaller than the target patterns and extracting the outlines of the target patterns using differences between the target patterns and the sub-target patterns.

14. The method of claim 11, wherein the first image comprises first and second target patterns directly adjacent to each other, and the second image comprises a line shape located between the first target pattern and the second target pattern.

15. The method of claim 14, wherein generating the first image further comprises:
generating a first quadrilateral shape corresponding to the first target pattern;
generating a second quadrilateral shape corresponding to the second target pattern;
generating a third quadrilateral shape by connecting the first and second quadrilateral shapes;
removing the first and second target patterns from the third quadrilateral shape; and
extracting the line shape extending along a lengthwise direction of the third quadrilateral shape from a remaining portion of the third quadrilateral shape.

16. A system configured to locate patterns for measurement in a captured Scanning Electron Microscope (SEM) image, the system comprising:
a processor circuit configured to generate a target pattern from a layout of a semiconductor device, and configured to generate a virtual image that corresponds to the target pattern, wherein elements of the virtual image less than completely overlap the corresponding portions of the target pattern, and is configured to locate portions of a captured SEM image of a fabricated semiconductor device that match the elements of the virtual image.

17. The system of claim 16 further comprising:
a Scanning Electron Microscope coupled to the processor circuit, the Scanning Electron Microscope configured to generate the SEM image of the fabricated semiconductor device.

18. The system of claim 16 wherein the elements of the virtual image that less than completely overlap the corresponding portions of the target pattern comprise outer edge portions of the target pattern that are exposed by the elements of the virtual image.

19. The system of claim 18 wherein the edge portions of the target pattern define polygonal shapes.

20. The system of claim 18 wherein the elements of the virtual image that less than completely overlap the corresponding portions of the target pattern comprise linear shapes that extend between directly adjacent outer edge portions of the target pattern.
